(19) United States
(12) Patent Application Publication
(10) Pub. No.: US 2025/0336241 A1
(43) Pub. Date: Oct. 30, 2025

(54) PREDICTIVE VEHICLE MAINTENANCE USING ESTIMATED COMPONENT WEAR

(71) Applicant: Textron Inc., Providence, RI (US)

(72) Inventors: Jonathan Daniel Bowen, North Augusta, SC (US); Gregory August Theodosakis, Martinez, GA (US); Russell William King, Evans, GA (US)

(73) Assignee: Textron Inc., Providence, RI (US)

(21) Appl. No.: 18/650,463

(22) Filed: Apr. 30, 2024

(51) Int. Cl. G07C 5/00

(52) U.S. Cl. CPC G07C 5/006

(57) ABSTRACT

A vehicle system includes a golf vehicle and at least one processing circuit. The golf vehicle includes a chassis, a body, tractive elements, a brake system, a suspension system, a motor, a battery coupled to the motor, and one or more sensors configured to acquire data associated with use of the golf vehicle and including at least an inertial measurement unit. The at least one processing circuit is configured to: acquire the data; determine an expected useful lifetime remaining for one or more components of the vehicle based on the data, the one or more components including at least one of the chassis, the body, the suspension, the motor, or the brake system; and display a notification prompting a user to replace the one or more components based on the expected useful lifetime remaining being below a replacement threshold.

### BACKGROUND

Off-road machines or vehicles are used in various scenarios for a variety of purposes. For example, all-terrain vehicles (“ATVs”) and utility task vehicles (“UTVs”) may be used for off-road exploration or performing a variety of tasks requiring off-road capabilities. Other lightweight or recreational machines (e.g., golf carts, lawnmowers, other chore products) can be used in a variety of other contexts to perform specific chores or to make travel between different locations more convenient.

In some instances, it can be difficult to predict the health of components of these off-road machines or vehicles, especially those components which are not easily accessible for inspection. The most common traditional maintenance strategy is a “fix-as-fail” approach, where parts are replaced upon functional failure. However, this approach can result in unpredictable vehicle availability and possible hazardous conditions when failures occur. An alternative is to pre-emptively replace critical components ahead of the end of their useful life. However, this approach wastes time and money to avoid vehicle-down scenarios.

### SUMMARY

One embodiment relates to a vehicle system. The vehicle system includes a golf vehicle including a chassis, a body, tractive elements, a brake system configured to brake the tractive elements, a suspension system, a motor, a battery coupled to the motor, and one or more sensors configured to acquire data associated with use of the golf vehicle, the one or more sensors including at least an inertial measurement unit. The vehicle system further includes at least one processing circuit having at least one processor and at least one memory. The at least one memory stores instructions thereon that, when executed by the at least one processor, cause the at least one processor to acquire the data. The instructions further cause the at least one processor to determine an expected useful lifetime remaining for one or more components of the vehicle based on the data, the one or more components including at least one of the chassis, the body, the suspension, the motor, or the brake system. The instructions further cause the at least one processor to display a notification prompting a user to replace the one or more components based on the expected useful lifetime remaining being below a replacement threshold.

Another embodiment relates to a vehicle system. The vehicle system includes an inertial measurement unit and at least one processing circuit having at least one processor and at least one memory. The at least one memory stores instructions thereon that, when executed by the at least one processor, cause the at least one processor to receive event data associated with one or more events involving the vehicle from the inertial measurement unit. The instructions further cause the at least one processor to estimate an aggregate wear amount for one or more components of the vehicle based on the event data. The instructions further cause the at least one processor to display a notification prompting a user to replace the one or more components based on the aggregate wear amount.

Still another embodiment relates to a vehicle system. The vehicle system includes a non-transitory computer-readable medium having instructions stored thereon that, when executed by one or more processors, cause the one or more processors to acquire data associated with use of a golf vehicle. The instructions further cause the one or more processors to determine an expected useful lifetime remaining for one or more components of the golf vehicle based on the data, the one or more components including at least one of a chassis, a body, a suspension, a motor, or a brake system of the golf vehicle. The instructions further cause the one or more processors to display a notification prompting a user to replace the one or more components based on the expected useful lifetime remaining being below a replacement threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a flowchart of a method for tracking vehicle component wear and damage and predicting necessary vehicle maintenance, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, systems and methods are provided for effectively tracking vehicle component wear and damage and predicting necessary vehicle maintenance. For example, the systems and methods described herein use various sensor data collected during operation of a vehicle (e.g., acceleration or shock data and vibration data), to perform acute and cumulative assessments to approximate the wear and tear of various vehicle components. Beneficially, the systems and methods described herein allow for vehicles to be proactively maintained to eliminate component failures and unnecessary or otherwise inconvenient downtime, while simultaneously avoiding the waste of useful component life by predicting when the various components should actually be replaced based on an aggregated wear amount of each component compared to a corresponding expected wear lifetime and corresponding wear characteristics of each component.

### Overall Vehicle

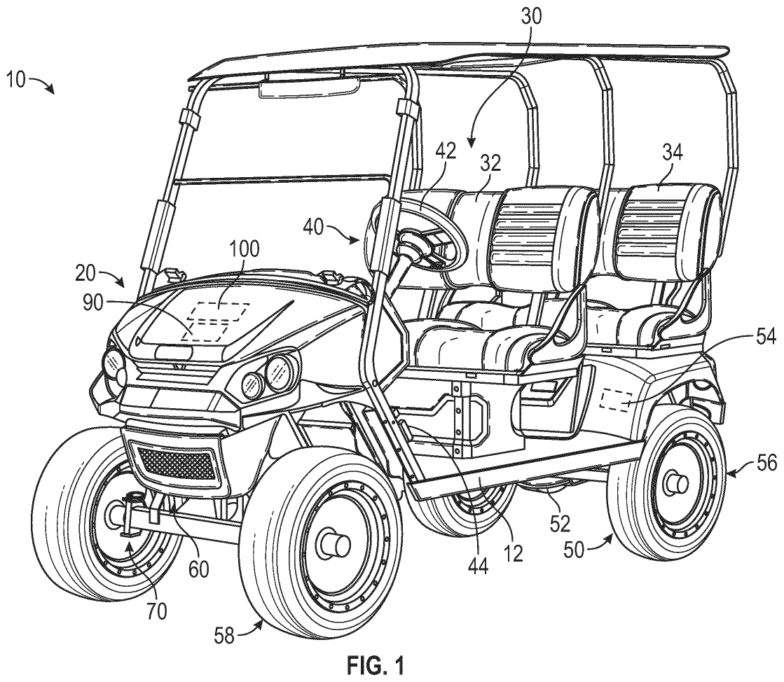

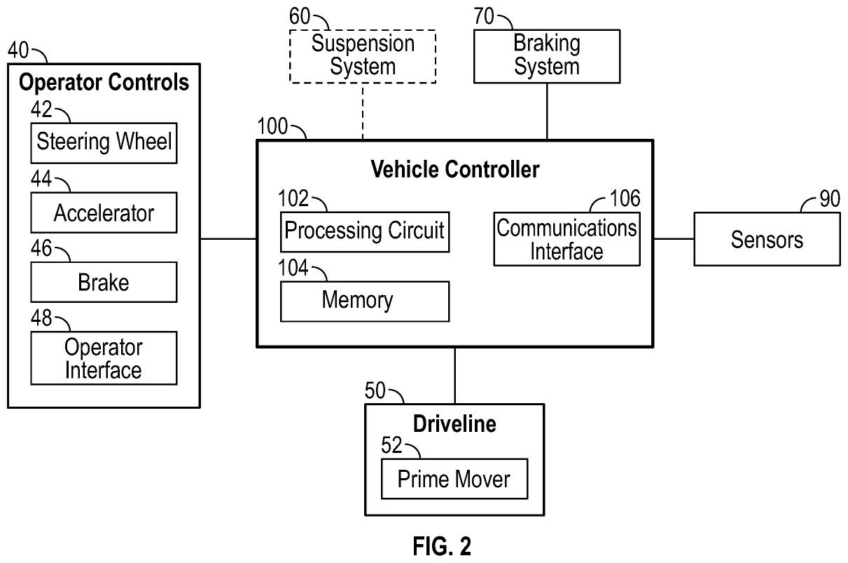

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown as steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., a traction motor) and the energy storage 54 is a battery system (e.g., a lithium battery system) including an on-board charger or chargeable via a separate charger. In some embodiments, the driveline 50 is a fuel cell electric driveline whereby the prime mover 52 is an electric motor (e.g., a traction motor) and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking functionality of the braking system 70 is supplemented or replaced with motor braking enabled by an electric motor (e.g., prime mover 52) that is also configured to propel the vehicle 10.

The sensors 90 may include various sensors positioned about the vehicle 10 to acquire vehicle information or vehicle data regarding operation of the vehicle 10 and/or the location thereof. By way of example, the sensors 90 may include an inertial measurement unit (“IMU”), an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, acceleration experienced by the vehicle 10, shock and vibrations experienced by the vehicle 10, sounds proximate the vehicle 10, braking events experienced by the vehicle 10, suspension travel of components of the suspension system 60, vehicle sound (e.g., engine exhaust noise, engine valvetrain noise, driveline noise) created by the vehicle, and/or other vehicle telemetry data. Although depicted as separate from the vehicle controller 100, in some instances, one or more of the sensors 90 may be incorporated into or otherwise embedded within the vehicle controller 100. Additionally, in some instances, one or more of the sensors 90 may be external sensors (e.g., an external GPS-tracking device that collects and calculates various measurements). Further, in some instances, multiple similar sensors (e.g., multiple IMUs) may be utilized (e.g., placed in different locations on the vehicle 10) to improve data quality.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102.

In some embodiments, the vehicle controller 100 may represent a collection of processing devices. In such cases, the processing circuit 102 represents the collective processors of the devices, and the memory 104 represents the collective storage devices of the devices. For example, in some embodiments, the vehicle controller 100 may comprise or otherwise represent a driveline controller (e.g., a motor controller), an energy storage management system (e.g., a battery management system), and/or any other control system of the vehicle 10.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106).

### Site Monitoring and Control System

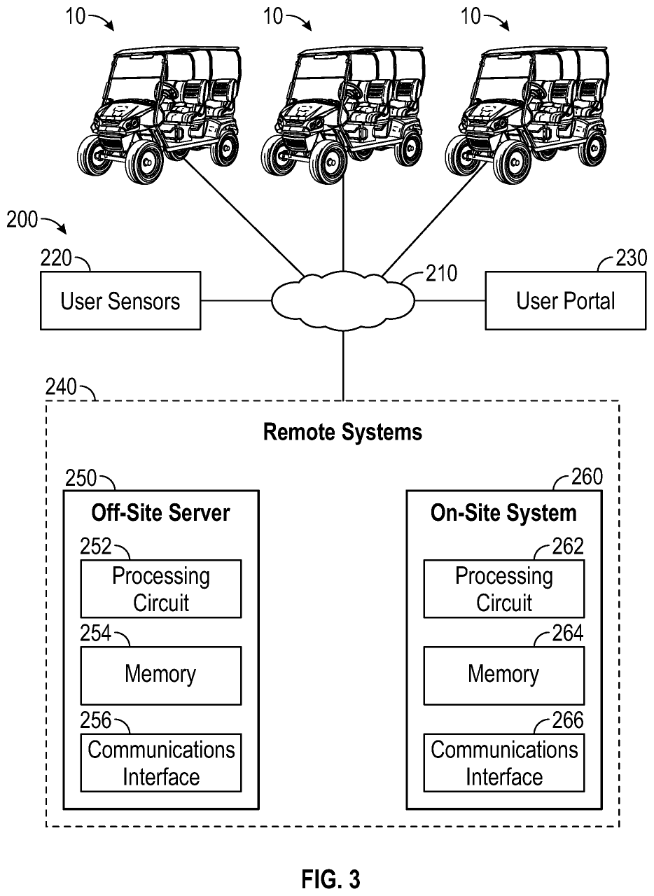

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266. In some embodiments, the off-site server 250 is a cloud-based server.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Predictive Vehicle Maintenance

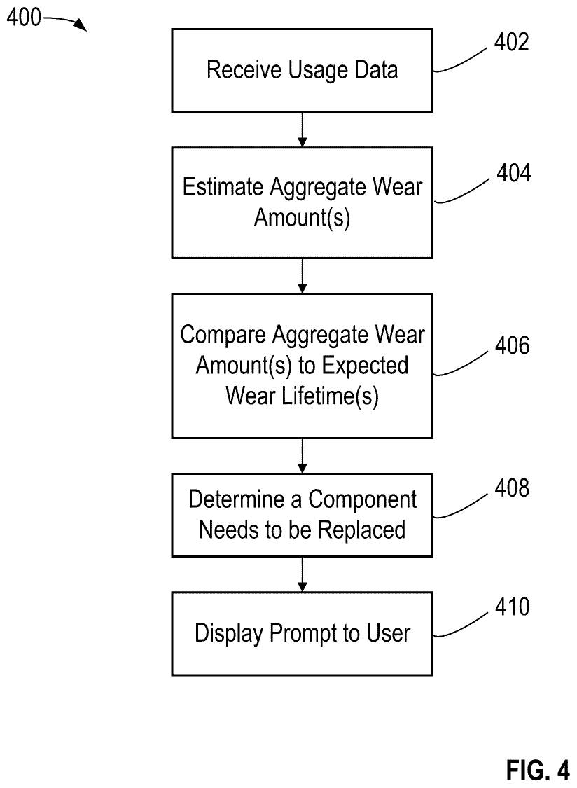

Referring now to FIG. 4, a method 400 for tracking vehicle component wear, misalignment or maladjustment (e.g., a system or subsystem coming out of alignment), and damage and predicting necessary vehicle maintenance is provided below. It should be appreciated that the following description is provided as an example and is in no way meant to be limiting. Furthermore, it should be appreciated that, in some embodiments, various steps may be added, omitted, and/or rearranged within the method 400 without departing from the scope of the present disclosure. In some embodiments, the method 400 is performed by the vehicle controller 100. In other embodiments, the method 400 is performed by one of the remote systems 240 (e.g., the off-site server 250 or the on-site system 260) or another cloud-based server configured to provide control commands to the vehicle 10. In some embodiments, the method 400 is performed by a combination of the vehicle controller 100 and the remote systems 240.

As a general overview, the method 400 allows for the vehicle controller 100 and/or the remote systems 240 to receive usage data (e.g., pertaining to events undergone by the vehicle 10) over time and to predict or estimate when various components of the vehicle 10 need to be replaced. It should be appreciated that, while the method 400 is described in the context of certain components of the vehicle 10, the vehicle controller 100 and/or the remote systems 240 can receive and utilize the same or other usage data types to predict when other components of the vehicle 10 and/or various components of other vehicles need to be replaced a similar manner.

The method 400 begins with the vehicle controller 100 and/or the remote systems 240 (e.g., via the network 210) receiving usage data associated with the vehicle 10, at step 402. The usage data is generally data corresponding to use of and events undergone by the vehicle 10. For example, usage data may be captured by one or more of the sensors 90 during operation of the vehicle 10. By way of example, the sensors 90 may include one or more accelerometers, one or more gyroscopes, an IMU within a controller of the prime mover 52 (e.g., a motor controller of a motor), an IMU within a GPS device installed on the vehicle 10, temperature sensors, current sensors, battery sensors, visual sensors (e.g., cameras), and/or other sensors disclosed herein. In some embodiments, data from multiple of the same type of sensor is used to improve data quality or otherwise enhance the data's predictive value. The usage data may include one or more of acceleration data associated with acceleration experienced by the vehicle 10, vibration data associated with vibrations experienced by the vehicle 10, operational data (e.g., braking data) associated with the vehicle 10, visual data pertaining to various components of the vehicle 10, motor or engine temperature data associated with the prime mover 52, motor or engine speed associated with the prime mover 52, current drawn by the prime mover 52, torque provided by the prime mover 52, temperature of the energy storage 54, output efficiency of the energy storage 54 (e.g., efficiency of battery output from the battery system), slope or grade data of the vehicle 10, GPS data associated with the vehicle 10, and/or any other pertinent data relevant to components wearing on the vehicle 10.

In some instances, the usage data is continuously collected during operation of the vehicle 10. As such, as the vehicle 10 experiences various events, the usage data associated with those events is collected and stored (e.g., in the memory 104, the memory 254, and/or the memory 264). Accordingly, the usage data can include data from a plurality of events experienced by the vehicle 10, such as, for example, typical use events (e.g., traveling over bumpy terrain, accelerating, braking, traveling uphill, traveling downhill, etc.), as well as more acute events (e.g., impact events, rollover events, etc.).

Accordingly, once the usage data is received, at step 402, an aggregate wear amount is estimated for a component of the vehicle 10, at step 404. For example, each event undergone by the vehicle 10 is assessed to estimate or predict how much wear that event likely caused to various components of the vehicle 10. In some instances, the wear that a given event is likely to have caused to different components of the vehicle 10 is estimated using one or more pattern matching algorithms that match observed usage data to historical usage data to estimate or predict the amount of wear caused on each component by the event based on corresponding wear amounts from similar past or historical events experienced by the vehicle 10 or other similar vehicles.

As one example, during operation of the vehicle 10, acceleration and deceleration data can be tracked during braking and/or acceleration events, and corresponding wear amounts can be estimated for braking components (e.g., brake pads, brake shoes), engine components (e.g., oil, oil pumps, water pumps, belts, starter/generator, battery, etc.), motor components (e.g., bearings, brushes, etc.), etc., based on similar past or historical braking and/or acceleration events. In some instances, a hard braking event (or, in some cases, sudden acceleration) generally corresponds to a larger amount of expected wear on the affected components, as compared to a soft braking event (or, in some cases, a more gradual acceleration event). In some instances, one or more weighting factors can be applied to the estimated wear amount to account for the braking or acceleration event being more or less intense than past or historical braking or acceleration events used in the matching algorithms discussed above.

As another example, vibration data can be tracked while the vehicle 10 is driven (e.g., vibrations caused due to the vehicle 10 driving over rocky or otherwise bumpy terrain), and a corresponding wear amount can be estimated for suspension components (e.g., suspension springs, dampers, bushings, etc.). In some instances, the vehicle 10 driving over rocky or bumpy terrain generally corresponds to a larger amount of expected wear of the affected components, as compared to the vehicle 10 being driven over flat or otherwise smooth terrain. In some instances, one or more weighting factors can be applied to the estimated wear amounts to account for the terrain being more rocky or bumpy than past or historical usage data used in the matching algorithms discussed above.

As yet another example, visual data associated with one or more components of the vehicle 10 can be captured via one or more visual sensors (e.g., cameras) as the vehicle 10 is driven. In some instances, this visual data can be tracked and a corresponding wear amount can be visually detected or verified from the visual data. For example, visual data associated with a brake pad can be collected (e.g., a video feed of the brake pad) and a wear amount can be determined or verified using the visual data.

As another example, in some instances, the vehicle controller 100 and/or the remote systems 240 can detect a system, subsystem, or other component of the vehicle 10 coming out of alignment or adjustment. In some instances, various signals obtained (e.g., via the sensors 90) and monitored by the vehicle controller 100 and/or the remote systems 240 can be used to detect various systems, subsystems, and/or other components of the vehicle 10 coming out of alignment or adjustment during operation. For example, certain systems (e.g., a vehicle valvetrain) may begin to make higher levels of noise as they come out of alignment or adjustment. Accordingly, upon detecting increased noise levels associated with these systems (e.g., via one or more sensors 90) during operation, the vehicle controller 100 and/or the remote systems 240 can determine that the systems are coming out of alignment and estimate when maintenance will be needed. Similarly, the vehicle controller 100 and/or the remote systems 240 can monitor tire pressure over time and/or suspension alignment (e.g., via tire pressure sensors and/or suspension angle sensors) over time to estimate when the tires will need to filled with air and/or when the suspension will need to be realigned.

As another example, in some instances, the vehicle controller 100 and/or the remote systems 240 can estimate a level of degradation of the motor (e.g., the prime mover 52) and/or driveline components of the vehicle based on various captured data tracked over time. For example, in some instances, a level of degradation of the motor and/or driveline components can be estimated by tracking the amount of torque produced by the motor to achieve the same constant speed on a known surface and grade (e.g., traveling on a flat/level paved surface at a constant speed of 15 mph). As the motor and/or driveline components degrade, the amount of torque produced by the motor needed to achieve the same constant speed on a known surface and grade may increase. Accordingly, by tracking this information, the amount of motor and/or driveline component degradation that has occurred can be predicted. In some instances, the vehicle controller 100 and/or the remote systems 240 can determine the torque achieved by the motor based on acceleration and vehicle orientation data captured via an IMU located within the motor controller.

In some instances, the level of motor and/or driveline component degradation can similarly be estimated by tracking a temperature rise per unit time of the motor and/or driveline components under given conditions. In these instances, as the motor and/or driveline components degrade, the temperature rise per unit time of the motor and/or driveline components under given conditions may generally increase over time. For example, if a typical motor and/or driveline component temperature rises three degrees Celsius per minute while traveling on level pavement at fifteen miles per hour, but it is detected that a temperature of the motor and/or driveline component is rising at six degrees Celsius per minute under the same conditions, this may be indicative that the motor and/or driveline component has degraded or that there are other conditions that need resolving. Accordingly, by tracking this information, the amount of motor and/or driveline component degradation that has occurred can similarly be predicted.

As another example, in some instances, the vehicle controller 100 and/or the remote systems 240 can estimate a level of battery degradation of the battery (e.g., the energy storage 54) based on various captured information tracked over time. For example, as the battery degrades, the battery may have a lower observed or estimated capacity and/or a decreased output efficiency while operating. Accordingly, the observed or estimated capacity and/or the output efficiency of the battery can be tracked over time to determine whether the observed or estimated capacity and/or the output efficiency of the battery in similar operating conditions (e.g., depletion rates, loading, running at similar speeds, on similar grades, at similar battery charge levels) has decreased over time. This decrease in the observed or estimated capacity and/or the output efficiency can then be used to estimate a level of battery degradation of the battery. In some instances, the battery's output efficiency can be determined based on a variety of factors, such as, for example, a maximum charge level of the battery, a maximum current output, an observed battery life, etc.

In addition to the general use events discussed above, various data can similarly be captured during more acute events, such as impact or crash events, rollover events, etc., and the wear and/or damage caused by the acute events can similarly be estimated or predicted using similar pattern matching algorithms to those discussed above.

For example, if the vehicle 10 experiences an impact event, acceleration data, braking data, and/or vibration data associated with the impact event can be used to determine a likely amount of wear and/or damage caused to various components of the vehicle 10. In some instances, the vehicle 10 experiencing a strong impact event generally corresponds to a larger amount of expected wear and/or damage, as compared to the vehicle 10 being in a moderate or weak impact event. In some instances, one or more weighting factors can be applied to the estimated wear amounts to account for the impact being more strong or violent than past or historical usage data used in the matching algorithms discussed above.

It will be appreciated that different components may be more or less affected by different event types. For example, the body 20 of the vehicle 10 may be most damaged by acute events like longitudinal impacts with other vehicles or obstacles, but may be largely unaffected by typical or ordinary use. Similarly, the frame 12 may accumulate small amounts of damage or wear from standard use (e.g., daily disturbances), but standard use events would cause less wear and be weighted less than damage from severe impacts (e.g., longitudinal impacts) and jounce events (e.g., vertical bouncing). On the other hand, internal components of the vehicle 10 may be less affected by acute events and more affected by normal use events. For example, braking components may be more affected by braking events than minor to moderate impact events.

In some instances, the vehicle controller 100 and/or the remote systems 240 may estimate the wear caused by a given event using multiple types of sensor data. For example, during a braking event, the vehicle controller 100 can receive deceleration data from one or more accelerometers or one or more IMUs onboard the vehicle 10, slope information pertaining to a slope that the vehicle 10 is driving on from one or more gyroscopes or one or more IMUs, and regenerative braking energy created by a motor (e.g., the prime mover 52) during a braking event and, based on this information, isolate the braking caused by the mechanical friction of brakes of the braking system 70 from other deceleration factors associated with the deceleration event (e.g., impact of a negative or positive slope, impact from regenerative braking, etc.). Accordingly, by isolating the mechanical friction aspect of the braking event provided by the mechanical friction brakes of the braking system 70, the vehicle controller 100 and/or the remote systems 240 can more accurately estimate the wear on the mechanical friction brakes caused by the deceleration event. It will be appreciated that, in other scenarios, various other combinations of sensor information can be combined to increase the accuracy of the wear and damage estimations described herein.

Accordingly, the vehicle controller 100 and/or the remote systems 240 (e.g., via the network 210) can continuously monitor usage data to detect various events and estimate associated wear and/or damage caused to different components of the vehicle 10. The vehicle controller 100 and/or the remote systems 240 can then aggregate the wear and/or damage caused to each of the various components to determine an aggregate wear or damage amount for each of the various components.

Once the aggregate wear amount is estimated for the component of the vehicle 10, at step 404, the aggregate wear amount is compared to an expected wear lifetime of the component, at step 406, and the vehicle controller 100 and/or the remote systems 240 then determine whether a component needs to be replaced, at step 408. For example, in some instances, expected wear lifetimes or wear attributes of each component of the vehicle 10 may be empirically tested and/or observed in similar components on similar vehicles and associated data or information may be stored by the vehicle controller 100 (e.g., within the memory 104) and/or the remote systems 240 (e.g., within the memory 254 and/or the memory 264) for use in determining when a given component will need to be replaced.

As an example, for the braking system, braking events (e.g., negative longitudinal accelerations) inferred from sensor data (e.g., IMU data) could be aggregated and compared with expected brake friction-material life (e.g., brake pads, brake shoes, etc.) that has been empirically tested and/or observed in similar components on similar vehicles.

It will be appreciated that different components generally wear at different rates over time. For example, a variety of components of the vehicle 10 may gradually wear out over time, such as suspension components (e.g., suspension springs, dampers, bushings, etc.), braking components (e.g., brake pads, brake shoes, etc.), engine and/or motor components, and/or various other components. Some other components are more susceptible to acute events, such as the body 20 and/or the frame 12, and these components may wear out or otherwise become damaged or broken immediately upon an acute event (e.g., an intense impact or crash). Accordingly, in some instances, different empirical or observed wear lifetimes or wear characteristics are stored for each component of the vehicle 10.

If a component needs to be replaced, the vehicle controller 100 and/or the remote systems 240 then displays a prompt to a user, at step 410. For example, in some instances, the vehicle controller 100 and/or the remote systems 240 displays an alert to the vehicle owner or operator via a display (e.g., the operator interface 48) on the vehicle 10. In other instances, the remote systems 240 displays the alert to the vehicle owner in a remote location (e.g., via the user portal 230 or a display of the remote systems 240) in, for example, a vehicle fleet application where the vehicle owner needs to track multiple vehicles.

In some instances, the alert provided to the vehicle owner or operator includes a notification indicating that an acute event has occurred (e.g., the vehicle 10 struck an object head-on, incurring a high negative acceleration) that may have damaged one or more components of the vehicle 10 (e.g., the body 20 of the vehicle 10). In some instances, the alert includes an indication that the aggregate wear amount for one or more components is over a predetermined threshold percentage (e.g., 95%) of the expected wear lifetime for the one or more components. In some instances, the alert further includes a list of each component that needs to be replaced. In some instances, the alert further includes an estimated useful lifetime remaining for each component (e.g., based on the aggregate wear amount and the expected wear lifetime). In any of these cases, the vehicle owner and/or operator would be prompted to perform a targeted vehicle inspection to verify that the one or more components need to be replaced, thereby minimizing risk of operator hazard or further property/component damage, while also saving diagnostic time.

In some instances, the vehicle controller 100 and/or the remote systems 240 may determine that one or more components will need to be replaced at some point in the future. For example, in some instances, multiple threshold percentages may be set for each component's corresponding aggregate wear amount. In these instances, a first warning threshold percentage (e.g., 75%) of the expected wear lifetime may be set as a threshold for warning the vehicle owner and/or operator that the corresponding component is nearing the end of its expected wear lifetime and will need to be replaced in the near future, while a second, higher replacement threshold percentage (e.g., 95%) may be set as a threshold for prompting the vehicle owner and/or operator that the corresponding component needs to be replaced as soon as possible.

In some instances, the vehicle controller 100 and/or the remote systems 240 may further determine a specific time that the one or more components will likely need to be replaced. For example, if the vehicle 10 is a golf cart used on a particular course, the vehicle controller 100 and/or the remote systems 240 may predict (e.g., based on historical wear trends per daily use on the course) that a certain component wears a certain amount each day of use, such that the estimated useful lifetime remaining can be used to predict when a particular component will need to be replaced in the future.

Accordingly, in some instances, the alert provided to the vehicle owner or operator may include one or more maintenance forecasts showing when various components will need to be replaced. In these instances, the vehicle owner or operator can then proactively procure parts and plan maintenance activities for convenient times. For example, in a fleet application setting (e.g., where the vehicle owner owns and manages multiple vehicles), this maintenance forecasting may allow for the vehicle owner to ensure that on-hand replacements parts stock is sufficient to repair their vehicles. Additionally, in some instances, these alerts could be transmitted to one or more vehicle service technicians in the area where the vehicles 10 are operated such that the service technicians can ensure that their replacement part stock is sufficient to service vehicles and fleets of vehicles from multiple sites in their area based on these predictive trends. Similarly, in some instances, one or more inspection interval recommendations for various vehicle components provided to the vehicle owner can be updated or otherwise established based on the estimated wear, misalignment or maladjustment, and/or damage described herein (e.g., “time to inspect your vehicle alignment,” “time to inspect your brakes,” etc.).

In some instances, the remote systems 240 may be configured to monitor an available stock of replacement parts of the vehicle owner or, in some instances, the service technician, and, in response to the amount of available replacement parts being less than an expected number of needed replacement parts (e.g., within the next month), the remote systems 240 may display a notification to the vehicle owner (or transmit the notification to the service technician) to purchase additional replacement parts. In some instances, the remote systems 240 may be associated with one or more remote maintenance service entities and/or databases configured to remotely monitor estimated wear, misalignment, and/or damage to plan for service of a plurality of vehicles (e.g., similar to the vehicle 10) for a given geological region (e.g., within a given city, county, state, country).

In some instances, the vehicle controller 100 and/or the remote systems 240 may continuously receive feedback relating to the repairs performed on a large number of vehicles similar to the vehicle 10 described herein, which may be used to continuously update and improve the wear, misalignment or maladjustment, and damage analysis (e.g., updating weighting factors, updating component wear rates, etc.) to more closely match real-world experience, fine-tuning the calibration of the wear and damage analyses. In some instances, this long-term tuning of the wear and damage analyses could be automated (e.g., via one or more machine learning algorithms). For example, in some instances, the vehicle controller 100 and/or the remote systems 240 may receive feedback pertaining to components replaced and/or adjusted during vehicle service appointments to correlate actual wear, misalignment or maladjustment, and/or damage levels of components to the wear, misalignment or maladjustment, and/or damage levels estimated for each vehicle using the methods described herein.

In some instances, the vehicle controller 100 and/or the remote systems 240 may additionally receive various feedback from the vehicle owner or another user. That is, upon alerting the user that it is time to replace, inspect, adjust, etc. a particular component of the vehicle 10, the vehicle owner or another user may either reset or “snooze” the alert based on their inspection. For example, if an alert is given for a particular component (e.g., “the steering rack is 75% worn and will need replacement soon”) and, upon inspection, the component does not appear to need maintenance or replacement, the vehicle owner or user may be able to select a particular “snooze” period (e.g., “remind me to re-inspect the steering rack in a month”). Alternatively, if, upon inspection, the component does appear to need maintenance or replacement, the vehicle owner or user may perform the maintenance or replacement and “reset” the alert (e.g., reset the steering rack wear estimate to 0%). In either case, the vehicle controller 100 and/or the remote systems 240 may update or adjust their wear estimate correlations for that component based on the vehicle owner or user feedback (e.g., reinforcing the wear estimate if it was correct or adjusting if it was incorrect).

In some instances, the vehicle controller 100 and/or the remote systems 240 may implement a feedback hierarchy including weighted adjustment factors that apply to vehicles and are used to tune, improve, or update the wear estimates described herein. For example, in some instances, vehicle-specific adjustment factors may be given the highest weight when updating wear estimate correlations for a given vehicle. Vehicle-specific adjustment factors may include monitored maintenance data (e.g., replacement feedback, adjustment feedback, inspection feedback) pertaining specifically to the vehicle for which wear is being estimated.

In some instances, after vehicle-specific adjustment factors, vehicle-type adjustment factors may be given a second highest weight when updating wear estimate correlations for a given vehicle. Vehicle type adjustment factors may include monitored maintenance data for all vehicles of a certain vehicle model, manufacturer, designer, etc. matching the vehicle for which wear is being estimated.

In some instances, after vehicle-type adjustment factors, course-or environment-specific adjustment factors may be given a third highest weight when updating wear estimate correlations for a given vehicle. Course-or environment-specific adjustment factors may include monitored maintenance data for all vehicles (e.g., any model, manufacturer, designer, etc.) at a specific course or at another specific environment.

In some instances, after course-or environment-specific adjustment factors, cluster adjustment factors may be given a fourth highest weight when updating wear estimate correlations for a given vehicle. Cluster adjustment factors may include monitored maintenance data for vehicles sharing other similar characteristics (e.g., region, temperature, manufacturing year, average sustained downhill braking time (brake wear can increase at higher brake pad temperatures), etc.) that are correlated with particular wearing tendencies. These similar characteristic/cluster identifications may be identified by the vehicle controller 100 and/or the remote systems 240 via one or more machine-learning algorithms configured to detect correlations between vehicle characteristics and wearing tendencies in vehicles.

In some instances, after cluster adjustment factors, global adjustment factors may be given a fifth highest (or lowest) weight when updating wear estimate correlations for a given vehicle. Global adjustment factors may include monitored maintenance data for all vehicles generally. These global adjustment factors may be given a lower weight than the previously mentioned adjustment factors because, while the global adjustment facts may still allow for gradual corrections to be made with respect to the original wear estimate correlations, they may be less pertinent to some specific vehicles, vehicle types, vehicles used at particular courses or in other particular environments, and/or vehicles having other identified similarities.

By weighting the previously discussed factors (e.g., the vehicle-specific adjustment factors, the vehicle-type adjustment factors, the course-or environment-specific adjustment factors, the cluster adjustment factors) in the order discussed above, the vehicle controller 100 and/or the remote systems 240 may achieve more accurate vehicle-by-vehicle wear estimation because maintenance data that is more relevant to each particular vehicle will be given a higher weight when dialing in or otherwise adjusting the wear estimation correlations for that specific vehicle.

It should be appreciated that, while the description of the method 400 above is provided largely in the context of an electric vehicle, the method 400 for tracking vehicle component wear and damage and predicting necessary vehicle maintenance can be similarly applied to any vehicle configured to receive usage data from one or more of the sensors described herein. For example, the method 400 can similarly be applied to a vehicle powered via an internal combustion engine, a fuel cell, a hybrid power source, or any other vehicle power type.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A vehicle system comprising:
a golf vehicle including:
a chassis;
a body;
tractive elements;
a brake system configured to brake one or more of the tractive elements;
a suspension system;
a motor configured to drive one or more of the tractive elements;
a battery coupled to the motor; and
one or more sensors configured to acquire data associated with use of the golf vehicle, the one or more sensors including at least an inertial measurement unit; and
at least one processing circuit having at least one processor and at least one memory, the at least one memory storing instructions thereon that, when executed by the at least one processor, cause the at least one processor to:
acquire the data;
determine an expected useful lifetime remaining for one or more components of the vehicle based on the data, the one or more components including at least one of the chassis, the body, the suspension, the motor, or the brake system; and
display a notification prompting a user to replace the one or more components based on the expected useful lifetime remaining being below a replacement threshold.

2. The vehicle system of claim 1, wherein the data includes one or more of acceleration data associated with the vehicle, vibration data associated with the vehicle, operational data associated with the vehicle, visual data associated with the one or more components, global positioning system data, braking data associated with the vehicle, motor temperature, motor speed, motor current, motor torque, battery temperature, or battery output efficiency.

3. The vehicle system of claim 2, wherein the one or more components include one or more components of the brake system, and wherein, to determine the expected useful lifetime remaining for the one or more components of the brake system, the instructions cause the at least one processor to:
track the acceleration data during one or more braking events to determine an amount of deceleration;
estimate an amount of wear caused to the one or more components of the brake system by the one or more braking events based on the acceleration data, which includes accounting for the slope of the ground upon which the golf vehicle is traveling on and an amount of regenerative braking applied using the motor; and
determine the expected useful lifetime remaining for the one or more components of the brake system based on the estimated amount of wear caused by the one or more braking events.

4. The vehicle system of claim 2, wherein the one or more components include one or more components of the suspension system, and wherein, to determine the expected useful lifetime remaining for the one or more components of the suspension, the instructions cause the at least one processor to:
track the vibration data during one or more driving events;
estimate an amount of wear caused by the one or more driving events based on the vibration data; and
determine the expected useful lifetime remaining for the one or more components of the suspension system based on the estimated amount of wear caused by the one or more driving events.

5. The vehicle system of claim 2, wherein the one or more components include one or more components of the motor or a driveline of the vehicle, and wherein, to determine the expected useful lifetime remaining for the one or more components of the motor or the driveline of the vehicle, the instructions cause the at least one processor to:
track one or more of the motor current, the motor torque, the motor speed, the motor temperature, or a temperature of a driveline component;
determine a level of motor or driveline component degradation based on the one or more of the motor current, the motor torque, the motor speed, the motor temperature, or the temperature of the driveline component; and
determine the expected useful lifetime remaining for the one or more components of the motor or the driveline of the vehicle based on the determined level of motor or driveline component degradation.

6. The vehicle system of claim 2, wherein the one or more components included one or more components of the battery, and wherein, to determine the expected useful lifetime remaining for the one or more components of the battery, the instructions cause the at least one processor to:
track one or more of the battery capacity or the battery output efficiency of the battery;
determine a level of battery degradation based on the one or more of the battery capacity or the battery output efficiency; and
determine the expected useful lifetime remaining for the one or more components of the battery based on the determined level of battery degradation.

7. The vehicle system of claim 1, wherein the data includes real-time usage data and historical usage data, and wherein to determine the expected useful lifetime of the one or more components, the instructions cause the at least one processor to:
determine a predicted aggregate wear amount for the one or more components caused by a plurality of usage events;
compare the predicted aggregate wear amount with an initial expected wear lifetime of the one or more components; and
determine the expected useful lifetime of the one or more components based on the comparison between the predicted aggregate wear amount and the initial expected wear lifetime.

8. The vehicle system of claim 1, wherein the notification prompting the user to replace the one or more components includes a recommended replacement time for replacing the one or more components based on the expected useful lifetime.

9. The vehicle system of claim 1, wherein the instructions further cause the at least one processor to:
determine an amount of available replacement components corresponding to the one or more components to be replaced; and
in response to the amount of available replacement components being less than an expected number of needed replacement components, display a second notification prompting a second user to purchase additional replacement components.

10. The vehicle system of claim 1, wherein the data is associated with a plurality of vehicles, determining the expected useful lifetime of the one or more components of the vehicle includes determining expected useful lifetimes of a plurality of components of the plurality of vehicles, and the notification prompts the user to replace the plurality of components of the plurality of vehicles.

11. The vehicle system of claim 1, wherein the at least one processing circuit is remote from the golf vehicle.

12. The vehicle system of claim 1, wherein the at least one processing circuit is onboard the golf vehicle.

13. The vehicle system of claim 1, wherein the inertial measurement unit is integrated into a motor controller of the motor.

14. The vehicle system of claim 1, wherein the golf vehicle includes a global positioning system; wherein the inertial measurement unit includes at least one of a first inertial measurement unit integrated into a motor controller of the motor or a second inertial measurement unit integrated in the global positioning system.

15. A vehicle system comprising:
an inertial measurement unit;
at least one processing circuit having at least one processor and at least one memory, the at least one memory storing instructions thereon that, when executed by the at least one processor, cause the at least one processor to:
acquire event data associated with one or more events involving the vehicle from the inertial measurement unit;
estimate an aggregate wear amount for one or more components of the vehicle based on the event data; and
display a notification prompting a user to replace the one or more components based on the aggregate wear amount.

16. The vehicle system of claim 15, wherein the instructions further cause the at least one processor to:
compare the aggregate wear amount for the one or more components with an expected wear lifetime of the one or more components; and
determine an expected useful lifetime remaining for the one or more components based on the comparison between the aggregate wear amount and the expected wear lifetime,
wherein the notification is displayed responsive to the expected useful lifetime remaining being below a replacement threshold.

17. The vehicle system of claim 16, wherein the notification prompting the user to replace the one or more components includes a recommended replacement time for replacing the one or more components based on the expected useful lifetime.

18. The vehicle system of claim 15, wherein the one or more components include one or more of a frame, a suspension, a body, a braking component, or prime mover of the vehicle.

19. The vehicle system of claim 15, wherein the event data includes one or more of acceleration data associated with the vehicle during the one or more events, vibration data associated with the vehicle during the one or more events, or operational data associated with the vehicle during the one or more events.

20. A vehicle system comprising:
a non-transitory computer-readable medium having instructions stored thereon that, when executed by one or more processors, cause the one or more processors to:
acquire data associated with use of a golf vehicle;
determine an expected useful lifetime remaining for one or more components of the golf vehicle based on the data, the one or more components including at least one of a chassis, a body, a suspension, a motor, or a brake system of the golf vehicle; and
display a notification prompting a user to replace the one or more components based on the expected useful lifetime remaining being below a threshold.
